(19) United States
(12) Patent Application Publication
(10) Pub. No.: US 2003/0148874 A1
(43) Pub. Date: Aug. 7, 2003

(54) Process and device for the reduction of radioactive waste and particularly from filters called iodine traps, in particular in nuclear centers and in centers for nuclear studies

(76) Inventor: Adolphe Weber, Rouhling (FR)

Correspondence Address: YOUNG & THOMPSON, 745 SOUTH 23RD STREET 2ND FLOOR, ARLINGTON, VA, 22202

(21) Appl. No.: 10/061,313

(22) Filed: Feb. 4, 2002

(30) Foreign Application Priority Data
Feb. 4, 2002 (FR) 00 01 458

(51) Int. Cl. B01J 20/34

(52) U.S. Cl. 502/30

(57) ABSTRACT

The present invention has for its object a process and a device for the reduction of radioactive wastes and particularly by regeneration of filters called iodine traps, in particular in nuclear centers and in centers for nuclear studies.

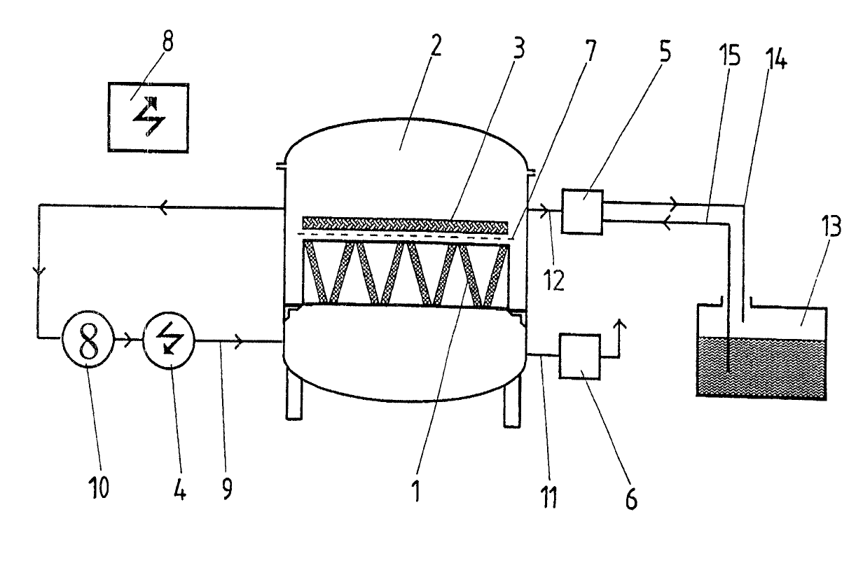

Process characterized in that it is practiced by means of a mobile device and consists essentially, on site, in placing at least one filter (1) in a chamber (2), without preliminary disassembly, circulating hot air in this chamber (2), creating a vacuum in the chamber (2), so as to extract the pollutants, then impregnating, under vacuum, the active carbon of the filter (1) by means of a chemical impregnation product (3) such as an amine or an amine derivative.

The invention is more particularly applicable to the field of treating nuclear waste, in particular by means of active carbon filters.

The present invention relates to the field of processing nuclear waste, in particular active carbon filters and has for its object a process for the reduction of radioactive waste and particularly by regeneration of filters called iodine traps, in particular in nuclear centers and in centers for nuclear studies.

The invention also has for its object a mobile device for practicing this process.

Active carbon has been used for many years for the absorption of gases, solvents, odors and in general all pollutants. Active carbon is used in bulk, in casings, in cells and in cartridges, particularly for the production of gas masks. This carbon is used in the raw condition or after treatment.

Such a treatment or impregnation can consist, in a known manner, of sprinkling or incorporation of metals such as copper, chromium, silver, etc. . . . , or of chemical compounds such as amines, namely hexamethylenetetramine, diethylenediamine, triethylenediamine, dicyclohexamine, and potassium iodide.

In the nuclear field, there are usually used metallic parallelepipedal cells or filters, comprising several beds of active carbon. This active carbon is held by means of grills of perforated metal spaced by about 5 cm in general and permits the filtration of air passing through said filter.

The cells are mounted groupwise in several units and thus form batteries of iodine traps. These cells have for their object to fix the radioactive iodinated compounds which could be released during a major incident at a nuclear reactor. Such a compound is dangerous and must in no case be able to diffuse into the atmosphere outside the reactor.

The active carbon used for iodine traps is generally, according to known processes, impregnated in the factory with potassium iodide and/or with amine, such as triethylenediamine, so as to increase the purification power relative to iodine.

The impregnation processes for carbon in bulk are particularly known from U.S. Pat. No. 4,531,953, EP 0 405 404 and U.S. Pat. No. 5,145,820. However, these processes are not adapted for the treatment of atmospheric cells for the filtration of nuclear material, because the carbon must, in this case be in direct contact with the impregnant. However, such contact is impossible to carry out in the exact case of cells which cannot be disassembled and emptied.

There is also known from DE 26 29 302 and from the publication 14^{th} Erda Cleaning Conference at Columbus, Ohio, 1976, processes for the regeneration of active carbon in bulk adapted to the nuclear field. However, these processes are not applicable to complete cells because the high temperatures required, of the order of 400° C. to 600° C., would destroy or deform the metallic structure of the cell.

Moreover, U.S. Pat. Nos. 4,040,802, 1,123,822 and EP 0 405 404 disclose processes for the impregnation by sprinkling with the help of aqueous solutions of potassium iodide and of triethylenediamine. The practice of these impregnation processes by sprinkling has the drawback of leading to corrosion of the perforated metallic envelope enclosing the active carbon and would render the latter unsuitable for reuse.

The filters called iodine traps “age” and “become poisoned”, for numerous reasons, namely because of the absorption of gases such as SO₂, NO₂, as well as the absorption of solvents and/or moisture, and further because of the oxidation of the impregnants. A “poisoned” cell becomes “inactive”, because it no longer has the required coefficient of purification. There is thus the necessity, according to the regulations in force, to replace said cell, which thus becomes a “nuclear waste” which is troublesome and requires appropriate treatment.

The present invention has for its object to overcome these drawbacks by providing a process and a device for reduction of nuclear waste and particularly by regeneration of filters called iodine traps, in particular in nuclear centers and in the centers for nuclear studies, permitting reducing the volume of nuclear waste produced by said centers and nuclear centers, by regenerating on-site the active carbon filters, and this without disassembling them and without emptying the carbon, so as to reuse them in place.

To this end, the process for reduction of radioactive waste and particularly for regeneration of filters called iodine traps, in particular in nuclear centers and in centers for nuclear studies, is characterized in that it is practiced with a mobile device and in that it consists essentially, on site, in positioning at least one filter in a chamber, without preliminary disassembly, circulating hot air in this chamber, creating a vacuum in the chamber so as to extract the pollutants, then impregnating, under vacuum, the active carbon with a chemical impregnation product such as an amine or an amine derivative.

The invention also has for its object a device for practicing this process, which is in the form of a mobile assembly essentially constituted by at least one vacuum chamber for the reception of at least one filter to be regenerated, by a heating device, by a vacuum pump with a liquid circuit for placing the chamber under vacuum for extraction, by a vacuum pump for creating a vacuum for impregnation, and by a heating grill for the reception of an impregnation product disposed above the filter to be regenerated, the different individual elements being controlled by means of a control and monitoring panel.

The invention will be better understood from the following description, which relates to a preferred embodiment, given by way of non-limiting example, and explained with reference to the accompanying schematic drawing, of which the single figure is a schematic view of a device for practicing the process according to the invention.

The accompanying drawing figure shows a mobile device for the reduction of radioactive wastes and particularly for filters called iodine traps, in particular in nuclear centers and in the centers for nuclear studies.

According to the invention, the process of reduction of radioactive waste and particularly by regeneration of filters called iodine traps, in particular in nuclear centers and in the centers for nuclear studies, is practiced by means of a mobile device and consists essentially, on site, in positioning at least one filter 1 in a chamber 2, without preliminary disassembly, circulating hot air in this chamber 2, creating a vacuum in the chamber 2 so as to extract the pollutants, then impregnating, under vacuum, the active filter of the filter 1 by means of a chemical impregnation product 3 such as an amine or an amine derivative.

The device for practicing this process is in the form of a mobile assembly, which is essentially constituted by at least one vacuum chamber 2 for reception of at least one filter 1 to be regenerated, by a heating device 4, by a vacuum pump 5 with a liquid circuit for placing under vacuum the chamber 2 for extraction, by a vacuum pump 6 for placing under vacuum for the impregnation, and by a heating grill 7 for receiving an impregnation product 3 disposed above the filter 1 to be regenerated, the different individual elements being controlled by means of a control and monitoring panel 8.

The heating device 4 is connected to the chamber 2 by means of a conduit 9 and the heating air is propelled through said conduit 9 and the device 4 by means of a fan 10.

The vacuum pump 5 with a liquid circuit for placing under vacuum the chamber 2 for extraction, is connected to the chamber 2 by a conduit 12 and is connected to a water reservoir 13 by means of conduits 14 and 15. This pump permits recovering all the soluble desorbate in the water reservoir 13 and thus avoids their expulsion into the ambient atmosphere. The vacuum pump 6 for placing under vacuum the chamber 2 for impregnation is connected to this latter by a conduit 11.

The heating of the filters in the chamber 2 is carried out at a temperature which is preferably comprised between 80° C. and 200° C. The vacuum created within the chamber 2 by means of the vacuum pump 5 with a liquid circuit is preferably comprised between 80 mbar and 120 mbar absolute, and this vacuum is maintained for at least 15 minutes.

The impregnation under vacuum of the filter 1 is carried out by sublimation of a heated chemical product, preferably at a temperature comprised between 40° C. and 80° C., under a vacuum maintained by means of the vacuum pump 6, between 5 mbar and 30 mbar absolute, and for a duration comprised between 15 hours and 20 hours.

The impregnation product is preferably an amine or an amine derivative and is preferably triethylenediamine.

According to a modified embodiment of the invention, the device for practicing the process could also comprise several chambers under vacuum, namely several individual chambers for heating and for desorption of the individual filters, and a larger chamber which can contain several filters, for carrying out the impregnation phase under vacuum. Thus it will be possible to increase substantially the rate of regeneration.

The control and monitoring panel 8 is connected to the different constituent elements of the device and permits controlling the assembly and monitoring the different parameters, namely the pressure and temperature and following their evolution over time, as well as that of the material.

Thanks to the invention, it is possible to proceed directly at a nuclear site, by means of a mobile regeneration device, to the regeneration of filters of the iodine trap type and to reuse these latter avoiding their being scrapped. As a result, the volume of waste resulting from the exploitation of nuclear sites can be substantially reduced.

Moreover, because of the mobility of the device for practicing the process, transportable from one nuclear site to another, it is unnecessary to provide as many installations as sites, so that the cost of regeneration is also reduced.

Of course, the invention is not limited to the embodiment described and shown in the accompanying drawing. Modifications remain possible, particularly as to the construction of the various elements or by substitution of technical equivalents, without thereby departing from the scope of protection of the invention.

1. Process for the reduction of radioactive waste and particularly by regeneration of filters called iodine traps, in particular in nuclear centers and in the centers for nuclear studies, characterized in that it is practiced by means of a mobile device and consists essentially, on site, in placing at least one filter (1) in a chamber (2), without previous disassembly, circulating hot air in this chamber (2), creating a vacuum in the chamber (2), so as to extract the pollutants, then impregnating, under vacuum, the active carbon of the filter (1) by means of a chemical impregnation product (3) such as an amine or an amine derivative.

2. Process according to claim 1, characterized in that the heating of the filters in the chamber (2) is carried out at a temperature which is comprised between 80° C. and 200° C.

3. Process according to claim 1, characterized in that the vacuum created within the chamber (2) by means of a vacuum pump (5) with a liquid circuit, for placing under vacuum the chamber (2) for the extraction, is preferably comprised between 80 mbar and 120 mbar absolute and this vacuum is maintained for at least 15 minutes.

4. Process according to claim 1, characterized in that the impregnation under vacuum of the filter (1) is carried out by sublimation of a heated chemical impregnation product (3), preferably at a temperature comprised between 40° C. and 80° C. under a vacuum maintained by means of a vacuum pump (6) for maintaining, under vacuum for impregnation, between 5 mbar and 30 mbar absolute and for a duration comprised between 15 hours and 20 hours.

5. Process according to claim 1, characterized in that the impregnation product is preferably an amine or an amine derivative and is preferably triethylenediamine.

6. Device for practicing the process according to any one of claims 1 to 5, characterized in that it is in the form of a mobile assembly essentially constituted by at least one vacuum chamber (2) for reception of at least one filter (1) to be regenerated, by a heating device (4), by a vacuum pump (5) with a liquid circuit for placing under vacuum the chamber (2) for extraction, by a vacuum pump (6) for placing under vacuum for impregnation, and by a heating grill (7) for receiving an impregnation product (3) disposed above the filter (1) to be regenerated, the different individual elements being controlled by means of a control and monitoring panel (8).

7. Device according to claim 1, characterized in that it comprises several chambers under vacuum, namely several individual chambers for heating and for desorption of individual filters and a larger chamber that can contain several filters for carrying out the vacuum impregnation phase.
